(19) United States
(12) Patent Application Publication
(10) Pub. No.: US 2021/0398712 A1
(43) Pub. Date: Dec. 23, 2021

(54) Wave Wire Flexible Shielding

(71) Applicant: PCT International, Inc, Tempe, AZ (US)

(72) Inventor: Leonard J. Visser, Huntsville, AR (US)

(73) Assignee: PCT International, Inc., Tempe, AZ (US)

(21) Appl. No.: 17/350,368

(22) Filed: Jun. 17, 2021

Related U.S. Application Data
(60) Provisional application No. 63/040,503, filed on Jun. 17, 2020.

(51) Int. Cl. H01B 11/00; H01B 11/18

(52) U.S. Cl. CPC H01B 11/005; H01B 11/1869; H01B 11/1813

(57) ABSTRACT

A cable with a wave wire flexible shield includes a cable core having an outer surface, and a plurality of wires surrounding the cable core, each of the wires having a wave shape as applied around the cable core.

### CROSS-REFERENCE TO RELATED APPLICATIONS

This application claims the benefit of U.S. Provisional Application No. 63/040,503, filed Jun. 17, 2020, which is hereby incorporated by reference.

### FIELD

The present specification relates generally to electronic devices, and more particularly to cables for electronic data communication.

### BACKGROUND

Electronic devices and components used in and around homes and businesses produce ingress noise affecting radio-frequency (“RF”) signals transmitted through nearby coaxial cables. Ingress noise can be caused by manufacturing or installation defects or imperfections in various electronic shielding. Conventional shielding that may have once been adequate is becoming less and less effective with the continuing proliferation of more and more electronic devices. Ingress noise has become a serious problem impacting signal quality in television, voice, security, and broadband services.

Shielding is used in a variety of cables and devices to reduce this outside electrical interference or noise that could affect an RF signal travelling through the cable or other system. The shielding also helps to prevent the internal signal from radiating from the cable or other system and interfering with other devices. Conventionally, flexible cable shielding often employs foil shields, serve shields (wire(s) wrapped in a helix around a cable core), or braid shields, either used alone or in some combination with each other.

Designing a shield requires balancing electrical performance with mechanical performance. Excellent electrical performance requires low resistance, high return loss, low passive intermodulation or “PIM” (which is increasingly desired by cellular network operators), and high screening efficiency. Excellent mechanical performance requires high flexibility, limpness, durability, resistance to damage caused by multiple flexures over the life of the cable, and minimums thickness. Cable manufacturers alter the materials and manufacturing methods of cables to find the right blend of all these characteristics, in an effort to obtain the desired electrical and mechanical performance for a particular cable.

Foil shields are shields constructed from thin tubes of metallic foil. Foil shields are too thin to provide low resistance or high screening efficiency, especially at low frequencies where the RF skin depth is much greater than the foil thickness. Foil shields also tend to crack after repeated flexing of the cable; this quickly leads to ineffectiveness as an RF shield.

Serve shields are shields constructed from tightly-grouped metallic wires wound helically around the core of the cable. They have low resistance and high limpness, but are poor shields against RF noise because of the solenoid effect. The helically-wrapped wires form a coil that resists alternating current and radiates the signal.

Braid shields overcome the solenoid problem of serve shields. Braid shields braid sets of wires in two opposing helical paths. However, braid shields are not as flexible as serve shields and are more than twice as thick, since the wires cross each other rather than winding as a set. These wire crossings can cause problems with return loss and PIM: the braided outer conductor can act like a myriad of loose connections that behave poorly when tested for PIM, especially as the cables age.

Common combinations of the prior art shields are bi-shield (a foil layer and a braid layer), tri-shield (an inner foil layer, a braid layer, and an outer foil layer), and quad-shield (an inner foil layer, an inner braid layer, an outer foil layer, and an outer braid layer). Cable manufacturers are still looking for different cabling solutions to yield desired performance characteristics, however.

### SUMMARY

A cable with a wave wire flexible shield includes a cable core having an outer surface, and a plurality of wires surrounding the cable core, each of the wires having a wave shape as applied around the cable core.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1A and 1B are side perspective views of electronic data communication cables with sinusoidal and triangular wave wire flexible shields, respectively;

FIGS. 2A and 2B show the periodicity of single wires from the wave wire flexible shields of FIGS. 1A and 1B, respectively, as presented on a scaled planar background;

FIG. 3 illustrates bind threads and binding tape on an electronic data communication cable;

FIGS. 4A and 4B illustrate partial views of a tape applied with wires useful for forming the wave wire flexible shields of FIGS. 1A and 1B, respectively; and

FIGS. 5A and 5B are generalized schematics of a machine for forming the wave wire flexible shield of FIG. 1A.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

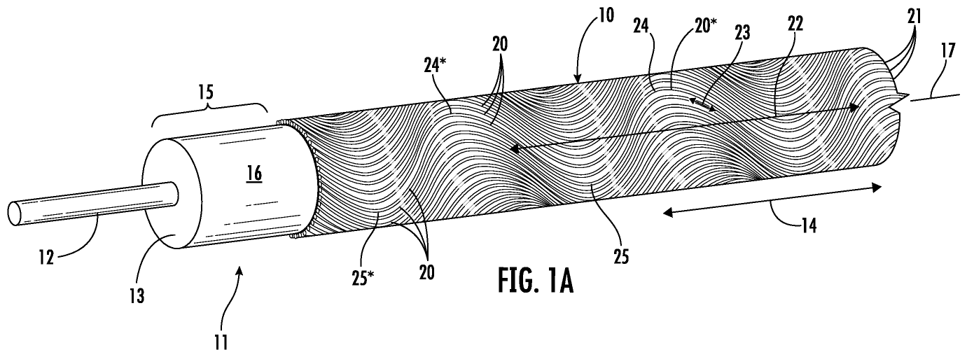

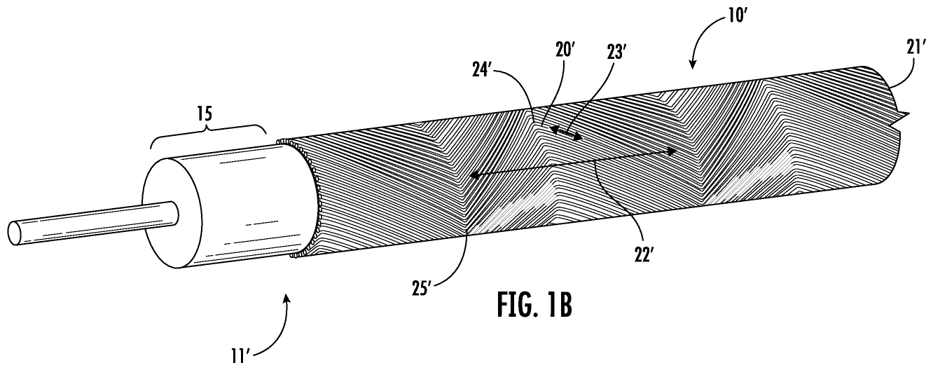

FIG. 1A illustrates a cable 11 constructed with a wave wire flexible shield 10 (or “wave shield 10” or “shield 10”). The cable 11 shown here as an example is a coaxial cable: it includes a center conductor 12 surrounded by an insulator 13. The cable 11 is shown without a jacket for purposes of the illustration only, to show the wave shield 10 along an axial length 14 of the cable 11. Typically, however, the cable 11 includes a protective jacket as the outer most layer of the cable 11 to protect and encapsulate the components of the cable 11. FIG. 1B illustrates another cable 11′ constructed with a different wave shield 10′. FIGS. 1A and 1B show two different exemplary embodiments of a wave shield, but they share common characteristics. Description is made first with respect to the cable 11 and wave shield 10 of FIG. 1A.

The cable 11 includes a cable core 15, and the wave shield 10 surrounds the cable core 15. In this exemplary embodiment of the cable 11, the cable core 15 includes the center conductor 12 and the insulator 13. In other embodiments, the cable core 15 has other components and does not necessarily form a coaxial cable. The cable core 15 has an outer surface 16, to which the wave shield 10 is applied directly. In the embodiment shown in FIG. 1A, the outer surface 16 is the cylindrical outer surface of the insulator 13. The cable 11 further includes a longitudinal axis 17 extending along the length 14 of the cable 11.

The wave shield 10 includes a plurality of wires 20 or wire strands. The wires 20 are preferably cylindrical, but may also be square wires. The wires 20 are constructed from a material having good flexibility and electrical conductivity characteristics, such as copper, aluminum, a combination thereof, or like metals or combinations of like metals. Collectively, the wires 20 surround the entire outer surface 16 of the cable core 15 along both its axial length 14 and its circumference.

The wires 20 are bent into cyclic wave shapes 21 and applied to the cylindrical cable core 15, thereby maintaining the cyclic wave shape 21 as applied around the cable core 15. In FIG. 1A, the wires 20 are shown spaced-apart; it can be seen in the terminations of the wires 20 (as shown to the left of the drawing) that each wire 20 is spaced apart from its neighbor by approximately the diameter of the wire 20. However, this is only for clarity of the illustration. The wires 20 are actually adjacent to each other without any spacing, but showing such a layout would render the drawing illegible and difficult to understand. As such, the reader should understand that FIG. 1A shows a non-limiting simplified view which this description explains.

Each wire 20 directly contacts the outer surface 16. Each wire 20 is also in continuous confrontation with the two wires immediately adjacent the particular wire 20 along the entire length of the wire 20 and along the entire axial length 14 of the cable core 15. The wires 20 thus collectively optically cover the entirety of the outer surface 16; the outer surface 16 cannot be seen when the wires 20 of the wave shield 10 are applied thereto. Use of the wave shape 21, as applied to the cylindrical cable core 15, permits the wires 10 to be laid up next to each other in tight confrontation without exposing the outer surface 16 underneath. Where lower coverage is desired, fewer wires 20 are used and gaps are permissibly allowed between the wires 20.

Each wire 20 of the wave shield 10 is bent into the cyclic wave shape 21. Each wave shape 21 is the same. The wires 20 thus may be and actually are nested against each other, each one circumferentially offset about the cylindrical outer surface 16 from another. A wave shape 21 is a form having a shape of a wave, generally having characteristics of frequency and amplitude, and often with the characteristics of periodicity and repetition. Wave shapes often periodically vary in amplitude over their lengths, though some wave forms—like chirps or impulses—do not have periodicity. The wave shape 21 of each wire 20 has an axis 22. FIG. 1A identifies an axis 22 of a particular wire 20* which is designated with an asterisk to set it apart from the other wires 20. However, wire 20* is identical in every respect to every other wire 20 except for circumferential disposition on the cable core 15. Similarly, the axis 22 is identical to the axes of all other wires 20 in every way except for circumferential disposition on the cable core 15; the axis 22 is just the axis which corresponds to the wire 20*.

The axis 22 of the wire 20* is parallel to the axis 17 of the cable 11. The axis 22 of the wire 20* defines a line about which the wire 20* cycles. The wire 20* has an orientation or alignment which changes with respect to the axis 22. In FIG. 1A, the orientation is identified with reference character 23 on a short double-arrowed line overlying the wire 20*; this orientation 23 is directed diagonally between the top-left corner of the page and the bottom-right corner of the page. However, the orientation 23 changes as the wire 20* bends. The wire 20* has maximums 24 and minimums 25. FIG. 1A identifies a first maximum 24 and a second maximum 24*, as well as a first minimum 25 and a second minimum 25*. The maximums 24 are maximum “high” points “above” the axis 22, while the minimums 25 are maximum “low” points “below the axis 22, analogous to the crest and trough of a sinusoidal wave. However, because the cable 11 is rotationally symmetric, “high” and “low” are relative to the orientation of the cable 11, and the maximums 24 and minimums 25 are actually merely opposite positions of maximum displacement of the wire 20* circumferentially away from the axis 22, in opposing circumferential directions. The maximums 24 and minimums 25 repeat periodically across the entire axial length 14 of the cable 11.

The orientation 23 of the wire 20* periodically changes along the axial length 14 because the wave shape 21 is cyclic and periodic. The orientation 23 from one maximum 24 to a neighboring minimum 25 is in one direction, and then, at the minimum 25, the orientation 23 changes direction toward the next neighboring maximum 24. In other words, the orientation 23 switches direction each time the wire 20* reaches a maximum 24 or minimum 25. Because the wave shape 21 is cyclic, this orientation 23 changes periodically and consistently. The orientation 23 shown in FIG. 1A with the double-arrowed line inverts beyond the neighboring maximum 24 and minimum 25.

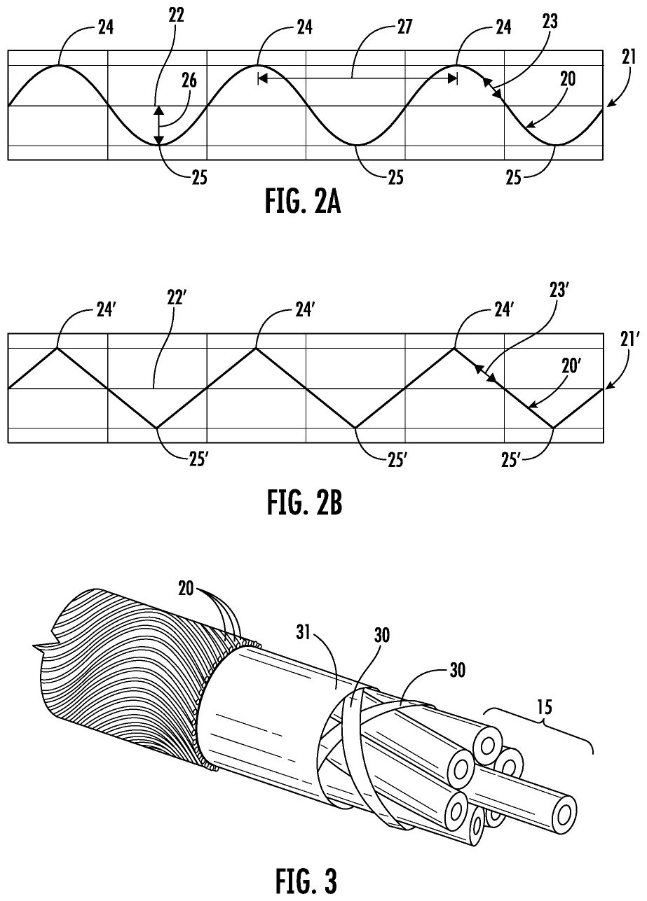

FIG. 2A shows this periodicity of the sinusoidal wave shape 21 of a single wire 20 presented on a scaled planar background. As seen there, the wire 20 alternates between maximums 24 and minimums 25 on either side of the axis 22. Each wave shape 21 has an amplitude 26 and wavelength 27 which may be adjusted for optimum performance. The amplitude 26 of the wave shape 21 is half the distance between the maximum 24 and minimum 25 of the wave shape 21, or half the distance between the extremities of the wave shape 21 aligned transverse to the axis 22. The wavelength of the wave shape 21 is the distance between two adjacent maximums 24 and 24—or two adjacent minimums 25 and 25—aligned parallel to the axis 22. A shorter wavelength 27 and greater amplitude 26 produce greater flexibility in the cable 11. A longer wavelength 27 and smaller amplitude 26 produce a cable 11 with lower longitudinal resistance which can be manufactured at higher production speeds.

As noted, the wire 20* in FIG. 1A is one of a plurality of wires 20 in the wave shield 10. There may be anywhere from thirty to one hundred wires 20 depending on the diameter and bend characteristics of the wires 20. In other embodiments of the cable 11, there may be a lesser or greater number of wires 20. The wires 20 are nested against each other, placing the maximums 24 of the wires 20 in circumferential alignment; local maximums 24 are disposed in common axial positions. Similarly, local minimums are disposed in common axial positions, though they are different and axially offset from the common positions of the maximums 24. And, because the wave shape 21 is periodic, those common positions of the maximums 24 and minimums 25 are periodic as well.

The wires 20 are laterally aligned on the outer surface 16 of the cable core 15. The wires 20 are preferably laid directly against the outer surface 16 and do not overlap or cross over or under one another. As such, in each axial location, wires 20 are laterally aligned; they are registered locally with each other and their respective orientations 23 are in the same direction locally. Moreover, the orientations 23 are parallel to the outer surface 16 of the cable core 15. “Locally” is used here to indicate that the orientation 23 or alignment of any wire 20 or wires 20 is localized in nature; because the orientation 23 changes across the length 14 of the cable core 15, the local orientation 23 at a particular location on the cable core 15, or at a particular axial position on the cable core 15, or at a particular circumferential disposition on the cable core 15, is used. In some embodiments, an adhesive layer is laid down between the central core 15 and the wave shield 10, while in other embodiments, no adhesive layer is used.

It has been discovered that the wave shield 10 has superior shielding. The wave shield 10 has a lower resistance than foil shields. It also eliminates the solenoid effect of serve shielding. It has been discovered that the wave shield 10 has greater flexibility than braid shields. The wave shield 10 has better durability than braid shields. It has also been discovered that the wave shield 10 has better PIM performance than a braid shield, potentially because it includes no wire crossings. The wave shield 10 also has a thinner size compared to a braid shield, which results in a smaller diameter cable, tighter bend radius, and lower manufacturing cost.

FIGS. 1A and 2A show an exemplary sinusoidal wave shape 21 of the wires 20 constructing the wave shield 10. Other wave shapes 21 may be used. For instance, in some embodiments, a square wave or a sawtooth wave shape could potentially be suitable. Irregular or damped sine waves and triangle waves may be suitable, depending on the application of the cable 10. Arbitrary wave shapes 21 without a constant periodicity are also not excluded from the scope of this disclosure: to the extent that wires 20 having such wave shapes 21 may be laid up on the central core 15 without consistent periodicity, they are intended to be included within this disclosure. In most cases, however, a sinusoidal or triangle wave is preferred.

FIGS. 1B and 2B show a cable 11′ constructed with an exemplary triangle wave. This description uses the prime (“′”) symbol to designate and differentiate the cable 11′ and wave shield 10′, and constituent structural elements and features thereof, from those of the cable 11 and wave shield 11. The cable 11′ is identical to the cable 11 in most respects. It includes a cable core 15 and a wave shield 10′ surrounding that cable core 15. The wave shield 10′ is the same as the wave shield 10 but uses a triangle wave shape 21′ instead of a sinusoidal wave shape 21′. The wires 20′ cycle on a periodic basis, changing orientations 23′ at maximums 24′ and minimums 25′. FIG. 2B shows one of the wires 20′ of the wave shield 10′ on the scaled, planar background.

Some embodiments of the cables use binder threads or binding tape. FIG. 3 shows both. Binder threads 30 wrap helically over the cable core 15. The binder threads 30 are thin flat ribbons of polyester or PTFE. The binder threads 30 may carry an adhesive on their outer surfaces to which the wires 20 adhere, thereby holding the wires 20 of the wave shield 10 tightly to the cable core 15. The binder threads 30 directly contact the outer surface 16 of the cable core 15, and the wires 20 of the wave shield 10 directly contact the outer surface of the binder threads 30. In other embodiments, binding tape 31 is used. Binding tape 31 is a wider, flat ribbon of polyester or PTFE, rolled into a cylinder to fit onto the cable core 15. Like the binder threads 30, the binding tape 31 has an adhesive which adheres the wires 20 to the outer surface of the tape 31. The binding tape 31 directly contacts the outer surface 16 of the cable core 15, and the wires 20 of the wave shield 10 directly contact the outer surface of the binding tape 31. In still other embodiments, binder threads 30 and/or binding tape 31 is placed outside of the wave shield 10, which assists during manufacturing in keeping the wires 20 of the wave shield 10 in place after application onto the cable core 15 and just prior to the subsequent manufacturing operation. This is especially true when no adhesive layer is used to hold the wires 20 against the central core 15.

There are at least two methods of manufacturing the wave shield 10 (and the wave shield 10′). A first manufacturing method uses an SZ-stranding device. An SZ-stranding device includes a series of rotating jigs or discs with a plurality of holes formed axially therethrough and located near the perimeter of the disc. Individual wires 20 or wire strands are fed through the holes in the discs, and the cable core 15 is fed through a central hole in the disc, such that the wires 20 surround the cable core 15. As the length 14 of cable core 15 is advanced through the SZ-stranding device, the discs rotate. The discs are rotated cyclically, first in a clockwise direction and then in a counter-clockwise direction. The speed at which the rotation occurs governs the form of the wave shape 21 of all of the wires 20. Rotating the discs with a sinusoidal speed variation arranges the wires 20 in a sine wave shape 21, as in FIG. 1A. Rotating the discs with a linear speed between reversals arranges the wires 20 in a triangular wave shape, as in FIG. 1B. Rotating the discs with other speeds arranges the wires 20 in other wave shapes 21.

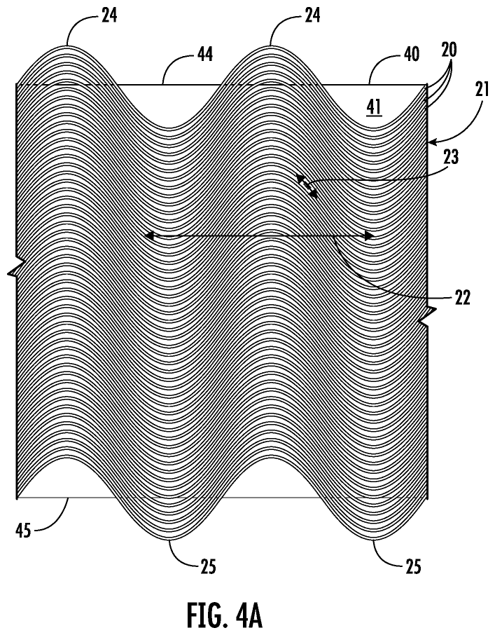

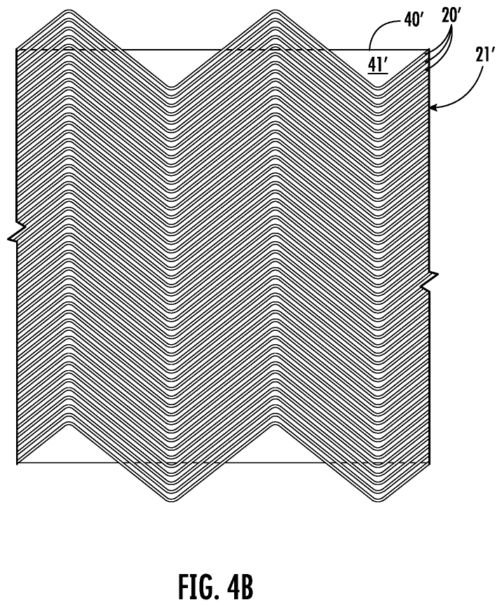

A second manufacturing method initially assembles the wave shield 10 onto a flat, planar tape 40, as FIG. 4A shows in partial view. The individual wires 20 are bent into the desired cyclic wave shapes 21 and adhered to a planar surface 41 of planar tape 40. The surface 41 is preferably covered with an adhesive such that the wires 20 adhere to the surface 41. The tape 40, with the wires 20 adhered thereto, is then wrapped around the cable core 15 as the assembled wave shield 10. Preferably, the tape 40 is constructed from biaxially-oriented polyethylene terephthalate film (well-known under the tradename Mylar®) with an adhesive surface. In other embodiments, the tape 40 is constructed from a metal, such as a metal foil, with an adhesive surface. A wave shield 10 with a metal foil tape 40 is preferable for use in tri-shield and quad-shield cable constructions. FIG. 4A shows, in part, a tape 40 applied with fifty wires 20 according to a sinusoidal wave shape 21, while FIG. 4B shows, in part, a tape 40′ with a surface 41′ applied with fifty wires 20′ according to a triangle wave shape 21′.

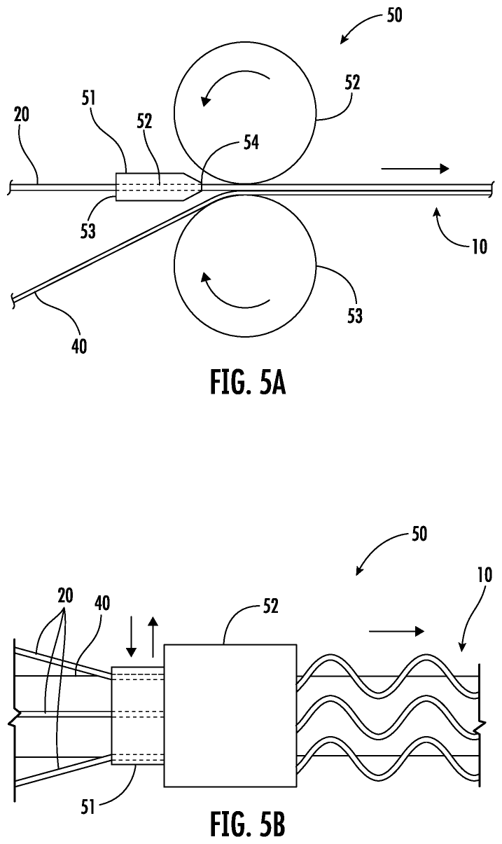

To construct a wave shield 10 according to the second manufacturing method, the machine 50 shown schematically in FIGS. 5A and 5B is used. Those drawings show wires 20, adhesive tape 40, and a shuttle 51 that guides the wires 20 into large, opposed pinch rollers 53 and 54. The pinch rollers 53 and 54 press the wires 20 onto the tape 40 to form the wave shield 10.

The shuttle 51 is a block, formed with a plurality of holes 52 corresponding to the plurality of wires 20 to be used in the wave shield 10 being manufactured. The holes 52 are formed through the block from an upstream end 53 of the shuttle 51 entirely through to a downstream end 54. The holes 52 receive the plurality of wires 20 and group them together in close alignment. The shuttle 51 is mounted for oscillatory movement in the directions shown by the two arrowed lines in FIG. 5B.

The wires 20 are unspooled forwardly into the shuttle 51, which oscillates normal to the longitudinal axis of the tape 40. The tape 40 is fed below the shuttle 51 to just downstream of the shuttle 51. The pinch rollers 53 and 54 press the wires 20 onto the tape 40. When the shuttle 51 oscillates at the desired frequency, it arranges the wires 20 onto the tape 40 in the desired waveform. Cyclically oscillating the shuttle 51 at a changing speed, according to a sinusoidal speed variation, arranges the wires 20 into the sinusoidal wave shape 21 of FIG. 1A, while cyclically oscillating the shuttle 51 at a constant speed between direction reversals arranges the wires 20 into the triangle wave shape 21 of FIG. 1B. Preferably, the shuttle 51 is moved by a cam, actuator, or other device to produce the desired wave shape 21 precisely. The newly-formed planar wave shield 10 is then reeled onto a spool downstream of the machine 50, from which it later is unspooled and fed into a forming die that rolls the wave shield 10 into a cylinder around the cable core 15. Alternatively, the newly-formed wave shield 10 can be fed directly into the forming die after the pinch rollers 53 and 54.

Wave shields 10 are suitable for use in single layer shielded cables or in bi-shield cables, in which the shield includes a foil layer and a wave shield 10 layer. Wave shields 10 are suitable for use in tri-shield cables, in which the shield includes an inner foil layer, a wave shield 10 layer, and an outer foil layer. Wave shields 10 are also suitable for use in quad-shield cables, in which the shield includes one of: 1) an inner foil layer, inner wave shield 10 layer, outer foil layer, and outer wave shield 10 layer; 2) an inner foil layer, inner wave shield 10 layer, outer wave shield 10 layer, and outer foil layer; 3) an inner foil layer, outer foil layer, inner wave shield 10 layer, outer wave shield 10 layer; or 4) some other combination using a wave shield layer and a braid layer.

Further, the adhesive on the tape 40 may be intermittent or spaced apart (such as in a grid, checkerboard, or hash-stripe fashion) such that the adhesive allows electrical continuity between the metal foil of the tape 40 and the wires 20 adhered thereto. In other words, the adhesive does not insulate the wire 20 from the metal foil tape 40.

As an example, referring to FIG. 4A, the adhesive tape 40 shown has a width of sixteen millimeters, and fifty wires are adhered to its adhesive surface 41. The wires 20 are preferably formed from aluminum, copper, or tinned copper. Wave shields 20 are suitable for use in 50 or 75 ohm coaxial cables. They are also suitable for cables with multiple conductors, such as LAN twisted pair cables. Further, the wires 20 preferably have round or rectangular cross-sections (rectangular wires have more metal and thus lower resistance than round wires of the same optical coverage and thickness).

The wires 20 are arranged in a sinusoidal wave shape 21, each having a wavelength of four millimeters and an amplitude of three millimeters. The wavelength is preferably less than the RF signal's wavelength to avoid return losses; for frequencies in the 5 MHz to 3 GHz range, the wavelength is preferably forty millimeters or less. Each individual wire 20 is preferably 0.16 millimeters in diameter (approximately 34 AWG) and spaced apart from its adjacent wires by 0.32 millimeters. This provides a fifty percent optical coverage. In some embodiments, the wires 20 are not spaced apart at all and the resultant optical coverage is one hundred percent. The distance between individual wires 20 is set by the manufacturer according to the requirements of the use of the cable 10; manufacturers adjust this distance to achieve desired tradeoffs in shielding performance, flexibility, cost, and other factors. The maximum orientation 23 of the wires 20, between the maximums 24 and minimums 25, have an approximately thirty-degree angle with respect to the axis 22, which extends from the left side to the right side of the tape 40. In other embodiments, this angle is preferably between approximately eighteen and approximately forty-five degrees. Further, in other embodiments, the wires 20 may have another diameter, such as 36 AWG or 32 AWG.

FIG. 4A also shows that some of the wires 20, proximate their maximums 24 or minimums 25, extend beyond the upper and lower edges 44 and 45 of the tape 40, so that when the tape 40 is wrapped tightly around a cable core 15 having a 4.72 millimeter diameter, the upper and lower edges 44 and 45 of the tape 40 fit against each other in abutment, and the wires 20 overlapping those edges maintain the 0.32 millimeter spacing. In other words, when the tape 40 is wrapped onto the cable core 15, the wires 20 are arranged evenly across the cylindrical outer surface 16 of the cable core 15 without interruption at the seam between the two edges 44 and 45.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A cable with a wave wire flexible shield comprising:
a cable core having an outer surface; and
a plurality of wires surrounding the cable core, each of the wires having a wave shape as applied around the cable core.

2. The cable of claim 1, wherein the wires directly contact the cable core.

3. The cable of claim 1, further comprising a binding tape between the cable core and the wires, wherein the binding tape directly contacts the outer surface of the cable core and the wires directly contact the binding tape.

4. The cable of claim 1, wherein the wave shape of each wire is periodic.

5. The cable of claim 1, wherein each wire is in continuous confrontation with two of the wires which are adjacent to the respective wire.

6. The cable of claim 1, wherein the wires are laterally aligned on the outer surface of the cable core.

7. The cable of claim 1, wherein the wires optically cover the outer surface of the cable core.

8. The cable of claim 1, wherein:
each wire has an orientation that periodically changes along an axial length of the cable core between adjacent maximums and minimums of the wire, thereby defining the wave shape of the wire;
the maximums of all of the wires have common periodic axial positions; and
the minimums of all of the wires have common periodic axial positions different from the maximums.

9. The cable of claim 1, wherein the wave shape is one of a sinusoidal wave and a triangle wave.

10. A cable with a wave wire flexible shield comprising:
a cable core having an axial length;
a plurality of wires wrapped around the cable core, wherein each wire has an orientation that periodically changes along the axial length between adjacent maximums and minimums of the wire;
wherein the maximums of all of the wires have common periodic axial positions; and
the minimums of all of the wires have common periodic axial positions different from the maximums.

11. The cable of claim 10, wherein the wires surround the cable core.

12. The cable of claim 10, wherein the wires directly contact the cable core.

13. The cable of claim 10, further comprising a binding tape between the cable core and the wires, wherein the binding tape directly contacts the cable core and the wires directly contact the binding tape.

14. The cable of claim 10, wherein each wires has a periodic wave shape on the cable core.

15. The cable of claim 14, wherein the periodic wave shape is one of a sinusoidal wave and a triangle wave.

16. The cable of claim 10, wherein each wire is in continuous confrontation with two of the wires which are adjacent to the respective wire.

17. The cable of claim 10, the wires are laterally aligned on the cable core.

18. The cable of claim 10, wherein the wires optically cover the cable core.

19. A method of forming a wave wire flexible shield comprising:
providing a shuttle mounted for oscillatory movement;
providing opposed rollers downstream from the shuttle;
feeding an adhesive tape between the rollers;
feeding a plurality of wires into the shuttle and then between the rollers, thereby applying the wires to the adhesive tape; and
cyclically oscillating the shuttle to apply the wires to the adhesive tape in a cyclical layout.

20. The method of claim 19, wherein the step of cyclically oscillating further comprises cyclically oscillating at a constant speed.

21. The method of claim 19, wherein the step of cyclically oscillating further comprises cyclically oscillating at a changing speed.
